(19) United States
(12) Patent Application Publication
(10) Pub. No.: US 2025/0391611 A1
(43) Pub. Date: Dec. 25, 2025

(54) MULTILAYER CERAMIC CAPACITOR

(71) Applicant: SAMSUNG ELECTRO-MECHANICS CO., LTD., Suwon-si (KR)

(72) Inventors: Myunghyun Jo, Suwon-si (KR); Ban Seok Choi, Suwon-si (KR); Eunchae Park, Suwon-si (KR); Myungsik Kim, Suwon-si (KR); Geumhee Yun, Suwon-si (KR)

(73) Assignee: SAMSUNG ELECTRO-MECHANICS CO., LTD., Suwon-si (KR)

(21) Appl. No.: 19/057,885

(22) Filed: Feb. 19, 2025

(30) Foreign Application Priority Data
Jun. 25, 2024 (KR) 10-2024-0082381

(51) Int. Cl. H01G 4/30; H01G 4/012; H01G 4/12

(52) U.S. Cl. CPC H01G 4/30; H01G 4/012; H01G 4/1245

(57) ABSTRACT

A multilayer ceramic capacitor includes a ceramic body having a dielectric layer between first and second internal electrodes. The ceramic body satisfies the following conditional equation:

$$0 \leq ( a - b ) / a \leq 0.1 \qquad [ Conditional Expression ]$$

where
a: Indentation hardness (HIT) of a lower portion of the ceramic body
b: Indentation hardness (HIT) of an upper portion of the ceramic body

### CROSS-REFERENCE TO RELATED APPLICATION

This application claims priority to and the benefit of, Korean Patent Application No. 10-2024-0082381, filed with the Korean Intellectual Property Office on Jun. 25, 2024, the entire contents of which are incorporated herein by reference.

### BACKGROUND

### (a) Technical Field

The present disclosure relates to a multilayer ceramic capacitor.

### (b) Description of the Related Art

A multi-layered ceramic capacitor (MLCC), which is one of multilayer electronic components, is a chip-type condenser that is mounted on the printed circuit board of various electronic products such as video devices (OLED and LED), computers, smartphones, and mobile phones, and accumulates charge and releases it when necessary.

These multilayer ceramic capacitors may be used as components in various electronic devices because of their small size, high capacity, and easy mounting. As electronic devices such as computers and mobile devices become smaller and have higher output, the demand for high capacity and miniaturization of multilayer ceramic capacitors is increasing.

As multilayer ceramic capacitors become smaller, reliability of multilayer ceramic capacitors may deteriorate as the breakdown voltage (BDV) and mean time to failure (MTTF) decrease, which may require amelioration measures for addressing these issues.

### SUMMARY

One aspect of an embodiment provides a multilayer ceramic capacitor capable of improving breakdown voltage and average failure time.

Another embodiment of the present disclosure provides a multilayer ceramic capacitor including: a ceramic body configured to include a dielectric layer therein, and first and second internal electrodes facing each other with the dielectric layer provided therebetween, wherein the satisfies a following conditional equation:

$$0 \leq ( a - b ) / a \leq 0.1 \qquad [ Conditional Equation ]$$

wherein
a: Indentation hardness (HIT) of lower portion of ceramic body
b: Indentation hardness (HIT) of upper portion of ceramic body

When the ceramic body is divided into two based on a distance from an upper surface to a lower surface, a lower portion of the ceramic body may be a portion closest to the lower surface of the ceramic body, and an upper portion of the ceramic body may be a portion closest to the upper surface of the ceramic body.

When the ceramic body is divided into four based on a distance from an upper surface to a lower surface, a lower portion of the ceramic body may be a portion closest to the lower surface of the ceramic body, and an upper portion of the ceramic body may be a portion closest to the upper surface of the ceramic body.

When the ceramic body is divided into three based on a distance from an upper surface to a lower surface, a lower portion of the ceramic body may be a portion closest to the lower surface of the ceramic body, and an upper portion of the ceramic body may be a portion closest to the upper surface of the ceramic body.

The ceramic body may have an upper surface, which is the surface of the upper portion, and a lower surface, which is the surface of the lower portion. The upper surface is where pressure is applied during sintering of the ceramic body. It may further include a first external electrode connected to the first internal electrode, and a second external electrode connected to the second internal electrode.

According to at least one embodiment, the breakdown voltage (BDV) and mean time to failure (MTTF) may be improved by providing a multilayer ceramic capacitor with a small difference in indentation hardness (HIT) between the upper and lower portions.

### BRIEF DESCRIPTION OF THE DRAWINGS

FIG. 1 illustrates a perspective view of a multilayer ceramic capacitor according to an embodiment.

FIG. 2 illustrates a perspective view of upper and lower bisecting lines on a ceramic body separated from the multilayer ceramic capacitor of FIG. 1.

FIG. 3 illustrates a perspective view of upper and lower quarter lines on a ceramic body separated from the multilayer ceramic capacitor of FIG. 1.

FIG. 4 illustrates a perspective view of a ceramic body of the multilayer ceramic capacitor of FIG. 1 from a different side than that of FIGS. 2 and 3.

FIG. 5 illustrates a cross-sectional view taken along a line V-V′ of FIG. 1.

FIG. 6 illustrates an enlarged view of a portion A1 of FIG. 5.

FIG. 7 illustrates a plurality of dielectric green sheets.

FIG. 8 illustrates a stacked structure of a ceramic body using the dielectric green sheets of FIG. 7.

### DETAILED DESCRIPTION

Hereinafter, various embodiments of the present disclosure will be described in detail so that a person of ordinary skill in the technical field to which the present disclosure belongs can easily implement it with reference to the accompanying drawings. To clearly describe the present disclosure, parts that are irrelevant to the description in the drawings are omitted, and like numerals refer to like or similar constituent elements throughout the specification. Additionally, some components in the accompanying drawings are exaggerated, omitted, or schematically illustrated, and the size of each component does not fully reflect the actual size.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like will be used only to describe various components, and are not to be interpreted as limiting these components. The terms are only used to differentiate one component from other components.

It will be understood that when an element such as a layer, film, region, plate, etc. is referred to as being on another element, it can be directly on the other element or intervening elements may also be present. In contrast, when an element is referred to as being “directly on” another element, there are no intervening elements present. Further, in the specification, the terms “on” or “above” mean positioned on or below the object portion, and does not necessarily mean positioned on the upper side of the object portion based on a gravitational direction.

It will be further understood that terms “comprises”, “includes” or “have” used throughout the specification specify the presence of stated features, numerals, steps, operations, components, parts, or a combination thereof, but do not preclude the presence or addition of one or more other features, numerals, steps, operations, components, parts, or a combination thereof. Accordingly, unless explicitly described to the contrary, the word “comprise” and variations such as “comprises” or “comprising” will be understood to imply the inclusion of stated components but not the exclusion of any other components.

In the specification, the phrase “in a plan view” means when an object portion is viewed from above, and the phrase “in a cross-sectional view” means when a cross-section taken by vertically cutting an object portion is viewed from the side.

Throughout the specification, “connected” means that two or more components may be directly connected or indirectly connected through other components, physically or electrically. The term may also imply integration, depending on location or function. In describing a multilayer ceramic capacitor in this specification, a direction in which main components of the multilayer ceramic capacitor are stacked is defined as a ‘stacking direction’, but this may also be a ‘thickness direction’. Additionally, a direction parallel to a plane perpendicular to the stacking direction may be defined as a ‘planar direction’.

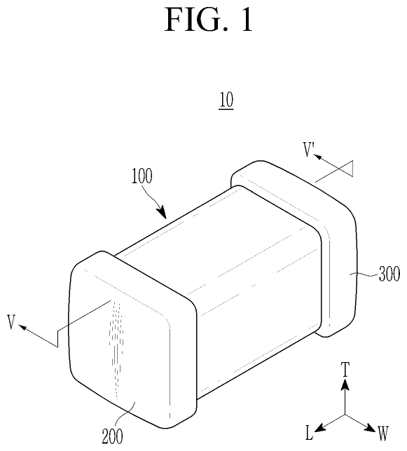

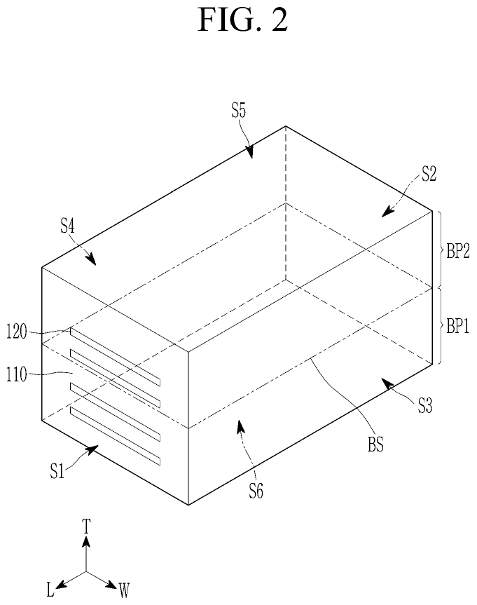

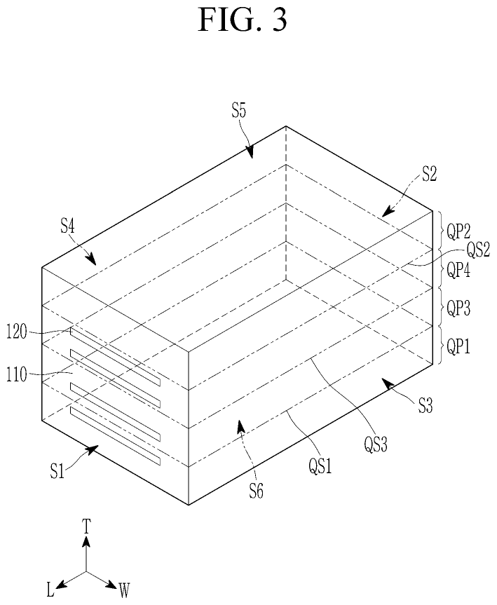

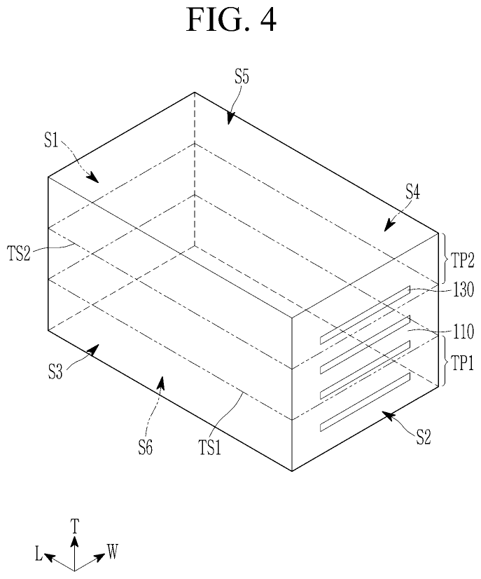

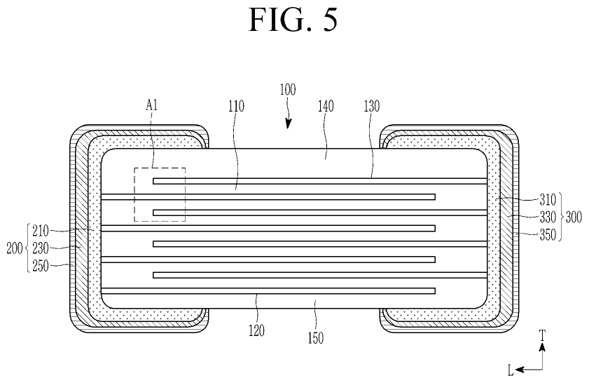

FIG. 1 illustrates a schematic perspective view showing a multilayer ceramic capacitor 10 according to an embodiment. FIG. 2 illustrates a perspective view showing bisecting lines on a ceramic body 100 separated from the multilayer ceramic capacitor of FIG. 1. FIG. 3 illustrates a perspective view showing quarter lines on the ceramic body 100 separated from the multilayer ceramic capacitor 10 of FIG. 1. FIG. 4 illustrates a perspective view showing the multilayer ceramic capacitor 10 of FIG. 1 from a different side than that of FIGS. 2 and 3. FIG. 5 illustrates a cross-sectional view taken along line V-V′ of FIG. 1.

Referring to FIGS. 1, 2, 3, 4, and 5, the multilayer ceramic capacitor according to the present embodiment includes a ceramic body 100, a first external electrode 200, and a second external electrode 300.

First, when directions are defined to clearly describe the present embodiment, L-axis, W-axis, T-axis indicated in the figures indicate axes representing a length direction, a width direction, and a thickness direction of the ceramic body 100, respectively.

The thickness direction (T-axis direction) may be a direction that is perpendicular to wide surfaces (main surfaces) of components each having a sheet shape. For example, the thickness direction (T-axis direction) may be used as a same concept as a direction in which the components of the ceramic body 100 are stacked.

The length direction (L-axis direction), which is the direction parallel to the wide surfaces (main surfaces) of the sheet-like components, may be a direction that intersects (or is orthogonal to) the thickness direction (T-axis direction). For example, the length direction (L-axis direction) may be a direction in which the first external electrode 200 and the second external electrode 300 face each other.

The width direction (W-axis direction), which is a direction parallel to the wide surface (main surface) of the sheet-like components, may simultaneously intersect (or orthogonal to) the thickness direction (T-axis direction) and the length direction (L-axis direction).

The ceramic body 100 may be formed in a substantially hexahedral shape, but the present embodiment is not limited to this. Due to shrinkage during sintering, the ceramic body 100 may have the substantially hexahedral shape, but not a perfect hexahedral shape. For example, the ceramic body 100 has a substantially rectangular parallelepiped shape, but portions corresponding to corners or vertices may have a rounded shape, and an outer portion of an upper portion thereof may have a shape that slopes downward.

In the present embodiment, for better understanding and ease of description, surfaces facing each other in the longitudinal direction (L-axis direction) are defined as a first surface S1 and a second surface S2, surfaces facing each other in the width direction (W-axis direction) and connecting the first surface S1 and the second surface S2 are defined as a third surface S3 and a fourth surface S4, and surfaces facing each other in the thickness direction (T-axis direction) and connecting the first surface S1 and the second surface S2 are defined as a fifth surface S5 and a sixth surface S6. In addition, hereinafter, the fifth surface S5 and the sixth surface S6 will be referred to as an upper surface S5 and a lower surface S6, respectively. The upper surface S5 is the portion where pressure is applied during sintering of the ceramic body 100.

Accordingly, a first direction in which the first surface S1 and the second surface S2 face each other may be the longitudinal direction (L-axis direction), and second and third directions perpendicular to the first direction and perpendicular to each other may be the thickness direction (T-axis direction) and the width direction (W-axis direction), respectively. In another example, a first direction in which the first surface S1 and the second surface S2 face each other may be the longitudinal direction (L-axis direction), and second and third directions perpendicular to the first direction and perpendicular to each other may be the width direction (W-axis direction) and the thickness direction (T-axis direction), respectively.

A length of the ceramic body 100 may indicate a maximum value among lengths of a plurality of line segments that connect two outermost boundary lines facing each other in the length direction (L-axis direction) of the ceramic body 100 illustrated in the cross-sectional photograph described above and are parallel to the length direction (L-axis direction) based on an optical microscope or scanning electron microscope (SEM) photograph for a cross-section of the ceramic body 100 in the length direction (L-axis direction)-thickness direction (T-axis direction) at a center in the width direction (W-axis direction). Alternatively, the length of the ceramic body 100 may refer to the minimum length among multiple line segments connecting two outermost boundary lines facing each other in the length direction (L-axis direction). These line segments are parallel to the length direction (L-axis direction). Alternatively, the length of the ceramic body 100 may indicate an arithmetic average value of the lengths of at least two line segments among a plurality of line segments that connect two outermost boundary lines facing each other in the length direction (L-axis direction) of the ceramic body 100 illustrated in the cross-sectional photograph described above and are parallel to the length direction (L-axis direction).

A thickness of the ceramic body 100 may refer to a maximum value among lengths of a plurality of line segments that connect two outermost boundary lines facing each other in the thickness direction (T-axis direction) of the ceramic body 100 illustrated in the cross-sectional photograph described above and are parallel to the thickness direction (T-axis direction) based on an optical microscope or scanning electron microscope (SEM) photograph for a cross-section of the ceramic body 100 in the length direction (L-axis direction)-thickness direction (T-axis direction) at a center in the width direction (W-axis direction). Alternatively, the thickness of the ceramic body 100 may refer to a minimum value among lengths of a plurality of line segments that connect two outermost boundary lines facing each other in the thickness direction (T-axis direction) of the ceramic body 100 illustrated in the cross-sectional photograph described above and are parallel to the thickness direction (T-axis direction). Alternatively, the thickness of the ceramic body 100 may refer to an arithmetic average value of the lengths of at least two line segments among a plurality of line segments that connect two outermost boundary lines facing each other in the thickness direction (T-axis direction) of the ceramic body 100 illustrated in the cross-sectional photograph described above and are parallel to the thickness direction (T-axis direction).

The width of the ceramic body 100 may refer to a maximum value among lengths of a plurality of line segments that connect two outermost boundary lines facing each other in the width direction (W-axis direction) of the ceramic body 100 illustrated in the cross-sectional photograph described above and are parallel to the width direction (W-axis direction) based on an optical microscope or scanning electron microscope (SEM) photograph for a cross-section of the ceramic body 100 in the thickness direction (T-axis direction)-width direction (W-axis direction) at a center in the width direction (W-axis direction). Alternatively, the width of the ceramic body 100 may refer to a minimum value among lengths of a plurality of line segments that connect two outermost boundary lines facing each other in the width direction (W-axis direction) of the ceramic body 100 illustrated in the cross-sectional photograph described above and are parallel to the width direction (W-axis direction). Alternatively, the width of the ceramic body 100 may refer to an arithmetic average value of the lengths of at least two line segments among a plurality of line segments that connect outermost boundary lines facing each other in the width direction (W-axis direction) of the ceramic body 100 illustrated in the cross-sectional photograph described above and are parallel to the width direction (W-axis direction).

Meanwhile, the length, width, and thickness of the ceramic body 100 may each be measured using a micrometer measurement method. According to this micro measurement method, measurement may be performed by setting a zero point with a micrometer with Gage R&R (repeatability and reproducibility), inserting the ceramic body 100 according to the present embodiment between tips of a micrometer, and turning a measuring lever of the micrometer. Meanwhile, when measuring a length of the ceramic body 100 using the micrometer measurement method, the length of the ceramic body 100 may refer to a value measured once or an arithmetic average of values measured multiple times. This may be equally applied to measuring the width and thickness of the ceramic body 100.

The ceramic body 100 includes a dielectric layer 110, a first internal electrode 120, a second internal electrode 130, a first cover layer 140, and a second cover layer 150.

The dielectric layer 110 may be stacked in the thickness direction (T-axis direction) of the ceramic body 100. Boundaries between dielectric layers 110 may be unclear. That is, a plurality of dielectric layers 110 may be viewed as an integrated structure. For example, the boundaries between the dielectric layers 110 may be so unclear that it is difficult to check without using a scanning electron microscope (SEM).

The dielectric layer 110 may include a ceramic material with a high dielectric constant. For example, the ceramic material may include a dielectric ceramic including a component such as BaTiO₃, CaTiO₃, SrTiO₃, or CaZrO₃. In addition, an auxiliary component such as a manganese (Mn) compound, an iron (Fe) compound, a chromium (Cr) compound, a cobalt (Co) compound, and a nickel (Ni) compound may be further included in these components. Examples of the dielectric layer include (Ba₁₋ₓCaₓ)TiO₃, Ba(Ti_{1-y}Ca_{y})O₃, (Ba₁₋ₓCaₓ)(Ti_{1-y}Zr_{y})O₃, or Ba(Ti_{1-y}Zr_{y})O₃, and the like in which Ca (calcium), Zr (zirconium), etc. are partially dissolved in BaTiO₃, but the present disclosure is not limited thereto.

In addition, the dielectric layer 110 may further include at least one of a ceramic additive, an organic solvent, a plasticizer, a binder, or a dispersant. For example, the ceramic additive may include a transition metal oxide, a carbide, a rare earth element, magnesium (Mg), or aluminum (Al).

In addition, a slurry for forming the dielectric layer 110 may include a binder. The binder provides plasticity or shape retention. The binder decomposes during sintering and may not remain in the dielectric layer 110 after the sintering.

The first internal electrode 120 and the second internal electrode 130 may be alternately stacked with the dielectric layer 110 provided therebetween. That is, a first internal electrode/dielectric layer/second internal electrode/dielectric layer structure may be repeatedly positioned inside the ceramic body 100. For example, an internal electrode closest to the fifth surface S5 of the ceramic body 100 may be the first internal electrode 120, and an internal electrode closest to the sixth surface S6 may be the second internal electrode 130. As another example, the internal electrode closest to the fifth surface S5 of the ceramic body 100 may be the second internal electrode 130, and the internal electrode closest to the sixth surface S6 may be the first internal electrode 120.

The first internal electrode 120 and the second internal electrode 130 have opposite polarities. The first internal electrode 120 and the second internal electrode 130 may be electrically insulated from each other by the dielectric layer 110 positioned therebetween.

The first internal electrode 120 and the second internal electrode 130 may be arranged to be offset from each other in the longitudinal direction (L-axis direction) with the dielectric layer 110 provided therebetween. That is, the first internal electrode 120 and the second internal electrode 130 may be arranged such that some portions overlap each other and other portions do not overlap each other in the thickness direction (T-axis direction). A first end portion of the first internal electrode 120 may be exposed through the first surface S1 of the ceramic body 100. In addition, the first end portion of the second internal electrode 130 may be exposed through the second surface S2 of the ceramic body 100. An end portion of the first internal electrode 120 exposed from the first surface S1 of the ceramic body 100 may be connected to the first external electrode 200. Additionally, the end portion of the second internal electrode 130, exposed through the second surface S2 of the ceramic body 100, may be connected to the second external electrode 300.

The first internal electrode 120 and the second internal electrode may be formed by printing conductive paste on a surface of the dielectric layer 110. In this case, the conductive paste may contain a conductive metal. For example, a conductive paste containing nickel (Ni) or a nickel (Ni) alloy may be printed on the surface of the dielectric green sheet 500 by screen printing or gravure printing to form an internal electrode. However, the present embodiment is not limited thereto.

For example, an average thickness of the first internal electrode 120 and the second internal electrode 130 may be approximately 0.1 μm or more and 2 μm or less.

Herein, a thickness of the internal electrode may refer to an average thickness of one internal electrode positioned between the two dielectric layers 110. The average thickness of the internal electrode may be the arithmetic average of the thickness of one internal electrode shown in the above-described cross-sectional photograph measured at 30 points evenly spaced in the longitudinal direction (L-axis direction), based on a scanning electron microscope (SEM) photograph at 10,000 magnification for a cross section in the longitudinal direction (L-axis direction) and thickness direction (T-axis direction) at a center portion of the ceramic body 100 in the width direction (W-axis direction).

When a voltage is applied to the first external electrode 200 and the second external electrode 300, charges are accumulated between the first internal electrode 120 and the second internal electrode 130 that are adjacent to each other. That is, capacitance may be obtained between the first internal electrode 120 electrically connected to the first external electrode 200 and the second internal electrode 130 electrically connected to the second external electrode 300. The capacitance of the multilayer ceramic capacitor 10 is proportional to the overlapping area of the first internal electrode 120 and the second internal electrode 130 that overlap each other along the thickness direction (T-axis direction).

The ceramic body 100 of the present embodiment may have a small difference in indentation hardness (HIT) depending on a position in the thickness direction (T-axis direction). That is, a difference in fired hardness between lower and upper portions of the ceramic body 100 may be small.

The indentation hardness (HIT), which is a measure of the resistance of a material to deformation or indentation by an applied force, may indicate resistance to permanent deformation and damage. The indentation hardness (HIT) may be measured through a Brinell hardness test, a Rockwell hardness test, a Vickers hardness test, a Knoop hardness test, etc. For example, the indentation hardness (HIT) may be measured using a nanoindenter. In general, during a ceramic green sheet stacking process, ceramic green sheets are stacked starting from a lower portion of the ceramic body 100, so pressure received is accumulated, and as a result, the indentation hardness (HIT) increases toward the lower portion of the ceramic body 100. When comparing the upper and lower portions of the ceramic body 100 according to a difference in accumulated pressure, a large difference in indentation hardness (HIT) occurs. The ceramic body 100 of the present embodiment may have a small difference in the indentation hardness (HIT) between the upper and lower portions. Specifically, the difference in the indentation hardness (HIT) between the upper and lower portions of the ceramic body 100 may be 10% or less. In other words, the following conditional equation may be satisfied.

$$0 \leq ( a - b ) / a \leq 0.1 \qquad [ Conditional Equation ]$$

Herein,
a: Indentation hardness (HIT) of lower portion of ceramic body
b: Indentation hardness (HIT) of upper portion of ceramic body

Herein, the lower portion of the ceramic body and the upper portion of the ceramic body may refer to portions of the ceramic body 100.

As an example, referring to FIG. 2, the lower and upper portions of the ceramic body 100 may be divided into two bisected surfaces BS based on a distance from the upper surface S5 to the lower surface S6 of the ceramic body 100. When the ceramic body 100 is divided into two portions as above, the lower portion of the ceramic body is a portion BP1 closest to the lower surface S6, and the upper portion of the ceramic body is a portion BP2 closest to the upper surface S5. That is, the lower portion of the ceramic body is a portion positioned between the first bisected surface BS and the lower surface S6, and the upper portion of the ceramic body is a portion positioned between the second bisected surface BS and the upper surface S5.

In another example, referring to FIG. 3, when the ceramic body 100 is divided into four portions based on the distance from the upper surface S5 to the lower surface S6 of the ceramic body 100, the lower and upper portions of the ceramic body may be defined as lowermost and uppermost portions, respectively. When divided into the four portions as above, the ceramic body 100 may be classified into a first portion QP1 positioned at the lowermost portion, a second portion QP2 positioned at the uppermost portion, and a third portion QP3 and a fourth portion QP4 positioned between the first portion QP1 and the second portion QP2. In this case, the lower portion of the ceramic body is the first portion QP1, and the upper portion of the ceramic body is the second portion QP2. When divided into four portions, the lower portion QP1 is closest to the lower surface S6, and the upper portion QP2 is closest to the upper surface S5. In a cross-sectional view, the ceramic body 100 may be divided into three portions based on a first cross-section QS1 positioned at a lowermost portion, a second cross-section QS2 positioned at an uppermost portion, and a third cross-section QS3 positioned between the first cross-section QS1 and the second cross-section QS2. In this case, the lower portion of the ceramic body is a portion positioned between the first cross-section QS1 and the lower surface S6, and the upper portion of the ceramic body is a portion positioned between the second cross-section QS2 and the upper surface S5.

In another example, referring to FIG. 4, when the ceramic body 100 is divided into three portions based on the distance from the upper surface S5 to the lower surface S6 of the ceramic body 100, the lower and upper portions of the ceramic body may be defined as lowermost and uppermost portions, respectively. When divided into the three portions as above, the ceramic body 100 may be classified into a first portion TP1 positioned at the lowermost portion, a second portion TP2 positioned at the uppermost portion, and a third portion positioned between the first portion TP1 and the second portion TP2. In this case, the lower portion of the ceramic body is the first portion TP1, and the upper portion of the ceramic body is the second portion TP2. When the ceramic body 100 is divided into the three portions as above, the lower portion of the ceramic body is a portion TP1 closest to the lower surface S6, and the upper portion of the ceramic body is a portion TP2 closest to the upper surface S5. In a cross-sectional view, the ceramic body 100 may be divided into three portions based on a first cross-section TS1 (lowermost) and a second cross-section TS2 (uppermost). In this case, the lower portion of the ceramic body is a portion positioned between the first cross-section TS1 and the lower surface S6, and the upper portion of the ceramic body is a portion positioned between the second cross-section TS2 and the upper surface S5.

The ceramic body 100 of the present embodiment may be manufactured by using a dielectric paste containing 10 wt % or more and 30 wt % or less of PVB (polyvinyl butyral) binder with a glass transition temperature (Tg) of 80° C. or higher and 90° C. or lower based on a weight of the ceramic. Accordingly, the ceramic body 100 may be manufactured such that the difference in the indentation hardness (HIT) in the thickness direction (T-axis direction) is small, and specifically, the ceramic body 100 may be manufactured with a difference in the indentation hardness (HIT) between the upper and lower portions of 10% or less.

If there is no difference in the indentation hardness (HIT) between the upper and lower portions of the ceramic body 100 or is small, a breakdown voltage (BDV) and a mean time to failure (MTTF) increase. For example, if the difference in the indentation hardness (HIT) between the upper and lower portions of the ceramic body 100 is 10% or less, the breakdown voltage (BDV) and the mean time to failure (MTTF) may be significantly increased.

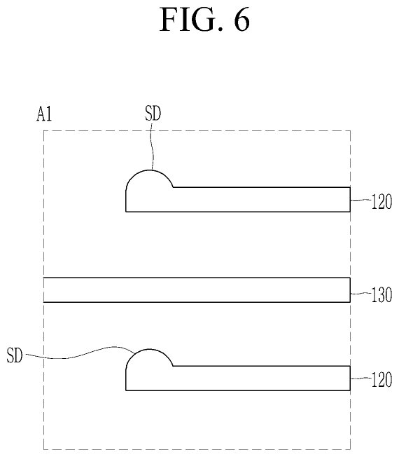

FIG. 6 illustrates an enlarged view of a portion A1 of FIG. 5.

Referring to FIG. 6, a saddle portion SD is generally formed at end portions of the first internal electrode 120 and the second internal electrode 130 (In FIG. 6, only the saddle portion of the first internal electrode is shown, but the saddle portion is also formed at the end portion of the second internal electrode 130). The ceramic body 100 of the present embodiment may be formed such that the difference in the indentation hardness (HIT) between the upper and lower portions is small, and accordingly, a height of the saddle portion SD may also be lowered. Accordingly, deformation of the dielectric layer 110 that occurs when the saddle portion is formed may be alleviated.

The first cover layer 140 and the second cover layer 150 may be disposed outside an active area A and a margin area M in the thickness direction (T-axis direction). The first cover layer 140 may be disposed between the fifth surface S5 of the ceramic body 100 and the internal electrode closest thereto. The second cover layer 150 may be disposed between the sixth surface S6 of the ceramic body 100 and the internal electrode closest thereto.

That is, the first cover layer 140 may be disposed over the internal electrode (hereinafter referred to as an ‘uppermost internal electrode’) positioned at an uppermost end based on the thickness direction (T-axis direction) among the internal electrodes. That is, the second cover layer 150 may be disposed under the internal electrode (hereinafter referred to as a ‘lowermost internal electrode’) positioned at a lowermost end based on the thickness direction (T-axis direction) among the internal electrodes. The first cover layer 140 and the second cover layer 150 may have the same composition as the dielectric layer 110. The first cover layer 140 may be formed by stacking one or more other dielectric layers on the uppermost internal electrode and a dielectric layer parallel to the uppermost internal electrode. In addition, the second cover layer 150 may be formed by stacking one or more other dielectric layers under the lowermost internal electrode and a dielectric layer parallel to the lowermost internal electrode.

The first cover layer 140 and the second cover layer 150 may serve to prevent damage to the first internal electrode 120 and the second internal electrode 130 due to physical or chemical stress.

The first external electrode 200 and the second external electrode 300 are positioned outside the ceramic body 100. The first external electrode 200 may be positioned on the first surface S1 of the ceramic body 100, and may extend to the third surface S3, the fourth surface S4, the fifth surface S5, and the sixth surface S6. The second external electrode 300 may be positioned on the second surface S2 of the ceramic body 100, and may extend to the third surface S3, the fourth surface S4, the fifth surface S5, and the sixth surface S6. In another embodiment, the first external electrode 200 and the second external electrode 300 may extend to a portion of at least one of the fifth surface S5 or the sixth surface S6.

The first external electrode 200 includes a first electrode layer 210 and a first conductive resin layer 230, and the second external electrode 300 includes a second electrode layer 310 and a second conductive resin layer 330.

The first electrode layer 210 and the second electrode layer 310 may contain a conductive metal and glass.

For example, the first electrode layer 210 and the second electrode layer 310 may include a conductive metal such as copper (Cu), nickel (Ni), silver (Ag), palladium (Pd), gold (Au), and platinum (Pt).), tin (Sn), tungsten (W), titanium (Ti), lead (Pb), an alloy thereof, or a combination thereof.

For example, the first electrode layer 210 and the second electrode layer 310 may include glass, and the glass may include a composition combining oxides. For example, the oxide may be one or more of a silicon oxide, a boron oxide, an aluminum oxide, a transition metal oxide, an alkali metal oxide, and an alkaline-earth metal oxide. The transition metal may be selected from zinc (Zn), titanium (Ti), copper (Cu), vanadium (V), manganese (Mn), iron (Fe), and nickel (Ni), the alkali metal may be selected from lithium (Li), sodium (Na) and potassium (K), and the alkaline earth metal may be one or more selected from magnesium (Mg), calcium (Ca), strontium (Sr), and barium (Ba).

The first conductive resin layer 230 and the second conductive resin layer 330 may contain a resin and a conductive metal.

The resin included in the first conductive resin layer 230 and the second conductive resin layer 330 is not particularly limited as long as it has bonding properties and shock absorption properties and can be mixed with conductive metal powder to make a paste. For example, the resin included in the first conductive resin layer 230 and the second conductive resin layer 330 may include a phenol resin, an acrylic resin, a silicone resin, an epoxy resin, or a polyimide resin.

The conductive metal included in the first conductive resin layer 230 and the second conductive resin layer 330 serves to electrically connect the first electrode layer 210 and the second electrode layer 310. The conductive metal in the first conductive resin layer 230 and the second conductive resin layer 330 may be spherical, flaky, or a combination of both.

The first external electrode 200 may include a first plating layer 250 positioned outside the first conductive resin layer 230, and the second external electrode 300 may include a second plating layer 350 positioned outside the second conductive resin layer 330.

The first plating layer 250 and the second plating layer 350 may include nickel (Ni), copper (Cu), tin (Sn), palladium (Pd), platinum (Pt), gold (Au), silver (Ag), tungsten. (W), titanium (Ti), lead (Pb), etc., alone or an alloy thereof. As an example, the first plating layer 250 and the second plating layer 350 may be a nickel (Ni) plating layer or a tin (Sn) plating layer, may be a form in which the nickel (Ni) plating layer and the tin (Sn) plating layer sequentially stacked, and may be a form in which the tin (Sn) plating layer, the nickel (Ni) plating layer, and the tin (Sn) plating layer are sequentially stacked. Additionally, the plating layer may include multiple nickel (Ni) plating layers, multiple tin (Sn) plating layers, or a combination of both.

The first plating layer 250 and the second plating layer 350 may improve mountability of the multilayer ceramic capacitor 10 to a substrate, structural reliability, external durability, heat resistance, and equivalent series resistance (ESR).

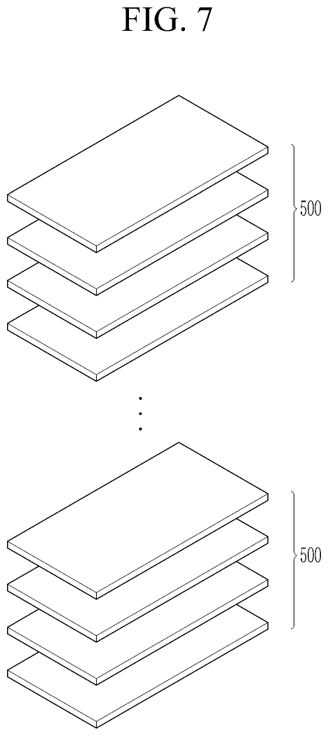

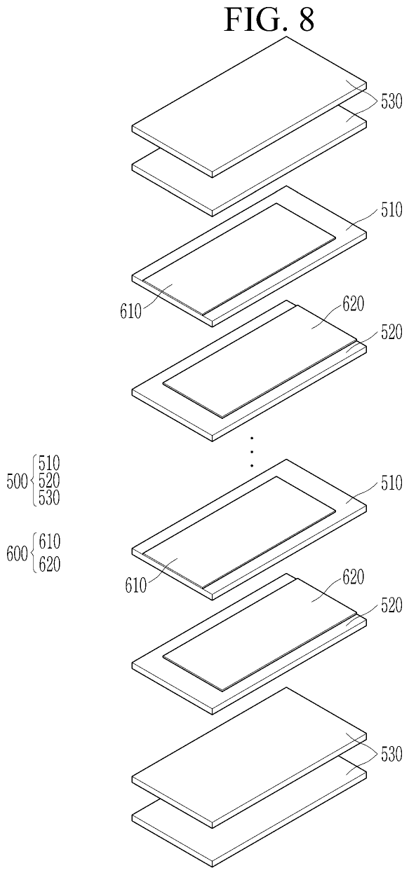

Hereinafter, a manufacturing method for the multilayer ceramic capacitor 10 according to an embodiment will be described with reference to FIG. 7 and FIG. 8.

FIG. 7 illustrates a plurality of dielectric green sheets. FIG. 8 illustrates a stacked structure of a ceramic body using the dielectric green sheets of FIG. 7.

First, a dielectric paste is prepared to form a plurality of dielectric green sheets 500. The dielectric paste may include ceramic powder, ceramic additive, organic solvent, plasticizer, dispersant, and binder.

For example, the ceramic powder may include a dielectric ceramic including a component such as BaTiO₃, CaTiO₃, SrTiO₃, or CaZrO₃. In addition, an auxiliary component such as a Mn compound, an Fe compound, a Cr compound, a Co compound, or a Ni compound may be further included in these components. For example, (Ba₁₋ₓCaₓ)TiO₃, Ba(Ti_{1-y}Ca_{y})O₃, (Ba₁₋ₓCaₓ)(Ti_{1-y}Zr_{y})O₃, Ba(Ti_{1-y}Zr_{y}O₃, or the like in which Ca and Zr are partially dissolved in BaTiO₃-based dielectric ceramic may be included.

For example, the ceramic additive may include a transition metal oxide, a transition metal carbide, a rare earth element, magnesium (Mg), aluminum (Al).

The organic solvent is not particularly limited, and examples may include butyl carbitol, acetone, toluene, ethyl acetate, etc.

The binder may be a polyvinyl butyral (PVB) binder, and a binder with a glass transition temperature (Tg) of 80° C. or more and 90° C. or less may be used. For example, the binder may further include at least one of polyacrylic acid ester, polymethacrylic acid ester, polyvinyl alcohol, cellulose dielectric, polyalkylene oxide, polyurethane, polyvinyl acetate, polyethylene, ethylene-vinyl acetate copolymer, or polyvinyl chloride. The dielectric paste of the present embodiment may include a binder in an amount of 10 wt % or more and 30 wt % or less based on a weight of the ceramic.

The dielectric paste may be provided through a disintegration process such that powders have uniform particles in an organic solvent. For example, ceramic powder, ceramic additive, organic solvent, plasticizer, dispersant, and binder may be charged in a hollow cylindrical crush mill, and the impeller provided in the crush mill may be rotated at a certain speed to crush the powder by torque. Additionally, a process to separate coarse particles and a filtering process to remove foreign substances may be performed.

Referring to FIG. 7, the dielectric green sheets 500 having a sheet shape of several μm thickness are manufactured using the dielectric paste provided above through methods such as doctor blade and scroll printing.

For example, the dielectric green sheets 500 may be manufactured by applying dielectric paste to a certain thickness on a film, then going through a filtering process and a drying process, and then removing the film.

A conductive paste layer 600 is disposed on surfaces of some of the dielectric green sheets 500. The conductive paste layer 600 becomes the first internal electrode 120 and the second internal electrode 130 after sintering. The conductive paste layer 600 may be formed by applying a conductive paste containing a conductive metal to the surface of the dielectric green sheet 500 using a method such as a doctor blade or screen printing method. As an example, the conductive metal may include a metal such as Ni, Cu, Ag, Pd, or Au, or an alloy thereof.

For example, the conductive paste layer 600 may be applied on the dielectric green sheet 500 in two patterns. Conductive paste may be applied to a surface of a first dielectric green sheet 510 in a first pattern to form a first conductive paste layer 610. In addition, the conductive paste may be applied to a surface of a second dielectric green sheet 520 in a second pattern to form a second conductive paste layer 620.

A dielectric green sheet stack is manufactured by stacking the dielectric green sheets 500.

When the first dielectric green sheet 510 and the second dielectric green sheet 520 are alternately stacked, the first pattern and the second pattern may be aligned such that some of the first conductive paste layer 610 and the second conductive paste layer 620 overlap and some do not overlap. The first conductive paste layer 610 forms into the first internal electrode 120 after sintering, and the second conductive paste layer 620 may become the second internal electrode 130 after sintering.

Referring to FIG. 8, a dielectric green sheet stack is formed by stacking dielectric green sheets. In this case, the first dielectric green sheet 510 and the second dielectric green sheet 520 are stacked such that the first conductive paste layer 610 and the second conductive paste layer 620 overlap, but at least some do not overlap.

A third dielectric green sheet 530 without a conductive paste layer formed is stacked on the first dielectric green sheet 510 and below the second dielectric green sheet 520.

The dielectric green sheet stack manufactured as described above is compressed. The pressure applied for compression may vary depending on composition of the dielectric green sheet or conductive paste, the size of the ceramic body 100, and atmospheric conditions such as temperature. A simulation may be performed to derive an appropriate pressure before performing the compression process. That is, by compressing the stack at a pre-calculated pressure, the ceramic body 100 with a small difference in indentation hardness (HIT) between upper and lower portions may be manufactured from a dielectric paste containing 10 wt % to 30 wt % of polyvinyl butyral (PVB) binder with a glass transition temperature (Tg) of 80° C. to 90° C. based on a ceramic weight.

During an operation of stacking or compressing the dielectric green sheet stack, flow of the dielectric green sheet may occur. Examples of the flow of this dielectric green sheet may include pore collapse, binder flow, and particle rearrangement. As dielectric green sheet flow occurs, the indentation hardness (HIT) of the entire ceramic body 100 may be determined. In this case, as described above, if the dielectric paste contains 10 wt % or more and 30 wt % or less of PVB binder with a glass transition temperature (Tg) of 80° C. or more and 90° C. relative to the weight of the ceramic, the ceramic body 100 may be formed such that the difference in the indentation hardness (HIT) between the upper and lower portions of the ceramic body 100 is 10% or less.

Selectively, the dielectric green sheet stack may be cut such that the first conductive paste layer 610 and the second conductive paste layer 620 are each exposed through opposite cross-sections of the dielectric green sheet stack.

The ceramic body 100 is manufactured by sintering the dielectric green sheet stack at a high temperature.

The first external electrode 200 is positioned on a cross-section of the ceramic body 100 where the first internal electrode 120 is exposed, and the second external electrode 300 is positioned on a cross-section where the second internal electrode 130 is exposed.

For example, the first external electrode 200 and the second external electrode 300 may be formed by applying a conductive paste on the ceramic body 100 and sintering it, or may be formed by plating. In addition, the first external electrode 200 and the second external electrode 300 may be formed by applying a conductive paste on the dielectric green sheet stack and then sintering the conductive paste together with the dielectric green sheet stack.

The following section describes specific examples of the invention.

### MANUFACTURING OF MULTILAYER CERAMIC CAPACITOR

### Manufacturing Method of Example 1

A plurality of dielectric green sheets with a thickness of 1.3 μm by applying a dielectric paste containing barium titanate (BaTiO₃) powder on a carrier film and drying it. The dielectric paste contained 22 wt % of PVB binder with a glass transition temperature (Tg) of 85° C. based on the weight of the ceramic.

A conductive paste containing nickel was applied to the dielectric green sheet using a screen printing method.

A dielectric green sheet stack was manufactured by stacking about 700 layers of dielectric green sheets coated with the conductive paste, and 55 layers of dielectric green sheets without conductive paste coated on top and bottom.

Isostatic pressing was performed on the dielectric green sheet stack under a pressure condition of 1000 kgf/cm² at 85° C.

The pressed dielectric green sheet stack was cut into individual chips and kept at 230° C. for 60 hours in an air atmosphere to perform binder removal.

Thereafter, sintering was performed at 1200° C. in a reducing atmosphere under an oxygen partial pressure of 10⁻¹¹ atm to 10⁻¹⁰ atm, which is lower than a Ni/NiO equilibrium oxygen partial pressure to prevent oxidation of the internal electrode.

Next, a multilayer capacitor (L×W×T=3.2 mm×1.6 mm×1.6 mm) was manufactured through processes such as external electrode formation and plating.

### Manufacturing Method of Example 2

In Example 1, a dielectric paste was prepared by including 25 wt % of PVB binder with a glass transition temperature (Tg) of 85° C. based on the weight of the ceramic. Except for this, a multilayer ceramic capacitor was manufactured in a same manner as in Example 1.

### Manufacturing Method of Example 3

In Example 1, a dielectric paste was prepared by including 30 wt % of PVB binder with a glass transition temperature (Tg) of 85° C. based on the weight of the ceramic. Except for this, a multilayer ceramic capacitor was manufactured in the same manner as in Example 1.

### Manufacturing Method of Example 4

In Example 1, a dielectric paste was prepared by including 20 wt % of PVB binder with a glass transition temperature (Tg) of 85° C. based on the weight of the ceramic. Except for this, a multilayer ceramic capacitor was manufactured in the same manner as in Example 1.

### Manufacturing Method of Example 5

In Example 1, a dielectric paste was prepared by including 10 wt % of PVB binder with a glass transition temperature (Tg) of 85° C. based on the weight of the ceramic. Except for this, a multilayer ceramic capacitor was manufactured in the same manner as in Example 1.

### Manufacturing Method of Comparative Example 1

In Example 1, a dielectric paste was prepared by including 28 wt % of PVB binder with a glass transition temperature (Tg) of 78° C. based on the weight of the ceramic. Except for this, a multilayer ceramic capacitor was manufactured in the same manner as in Example 1.

### Manufacturing Method of Comparative Example 2

In Example 1, a dielectric paste was prepared by including 14 wt % of PVB binder with a glass transition temperature (Tg) of 78° C. based on the weight of the ceramic. Except for this, a multilayer ceramic capacitor was manufactured in the same manner as in Example 1.

### Manufacturing Method of Comparative Example 3

In Example 1, a dielectric paste was prepared by including 28 wt % of PVB binder with a glass transition temperature (Tg) of 68° C. based on the weight of the ceramic. Except for this, a multilayer ceramic capacitor was manufactured in the same manner as in Example 1.

### Manufacturing Method of Comparative Example 4

In Example 1, a dielectric paste was prepared by including 11 wt % of PVB binder with a glass transition temperature (Tg) of 78° C. based on the weight of the ceramic. Except for this, a multilayer ceramic capacitor was manufactured in the same manner as in Example 1.

### Manufacturing Method of Comparative Example 5

In Example 1, a dielectric paste was prepared by including 25 wt % of PVB binder with a glass transition temperature (Tg) of 68° C. based on the weight of the ceramic. Except for this, a multilayer ceramic capacitor was manufactured in the same manner as in Example 1.

### Manufacturing Method of Comparative Example 6

In Example 1, a dielectric paste was prepared by including 14 wt % of PVB binder with a glass transition temperature (Tg) of 68° C. based on the weight of the ceramic. Except for this, a multilayer ceramic capacitor was manufactured in the same manner as in Example 1.

### Manufacturing Method of Comparative Example 7

In Example 1, a dielectric paste was prepared by including 11 wt % of PVB binder with a glass transition temperature (Tg) of 68° C. based on the weight of the ceramic. Except for this, a multilayer ceramic capacitor was manufactured in the same manner as in Example 1.

### Measurement of Insulation Breakdown Voltage and Mean Time to Failure

After manufacturing 40 multilayer ceramic capacitors of Examples 1 to 5and Comparative Examples 1 to 7 each, the breakdown voltage (BDV) and the mean time to failure (MTTF) were measured.

In addition, a ratio of dielectric thickness reduction was measured. The dielectric thickness reduction was obtained by using a method of calculating (Tc−Ts)/Tc by measuring a thickness Tc of a central portion (measured in the T-axis direction) and a thickness Ts of a portion where the saddle portion is positioned, for an uppermost dielectric layer (a dielectric layer between the first and second internal electrodes positioned at top).

Thereafter, the ceramic body 100 of the multilayer ceramic capacitor was separated into upper and lower portions, and indentation hardness (HIT) between the upper and lower portions was measured.

TABLE 1
Table
Table 1 summarizes measurement results thereof.

| | Indentation | Indentation | Indentation | BDV | BDV | | Dielectric |
|---|---|---|---|---|---|---|---|
| | hardness | hardness | hardness | Average | Minimum | | thickness |
| | (Lower | (Upper | Ratio(%) | value | value | MTTF | reduction |
| | portion) | portion) | (A-B)/A | (V) | (V) | (Hour) | (%) |
| Example 1 | 340.3 | 335.2 | 1.5 | 48 | 40 | 18 | 1.1 |
| Example 2 | 326.4 | 311.1 | 4.7 | 45 | 37 | 16.9 | 2 |
| Example 3 | 302.5 | 280.4 | 7.3 | 44 | 35 | 16.4 | 1.5 |
| Example 4 | 321.5 | 293 | 8.9 | 41 | 32 | 15 | 3.7 |
| Example 5 | 330.1 | 300.2 | 9.1 | 40 | 32 | 14.4 | 4 |
| Comparative | 201.2 | 180.6 | 10.2 | 32 | 22 | 8.9 | 5.5 |
| Example 1 | | | | | | | |
| Comparative | 220 | 189.7 | 13.8 | 31 | 21 | 8.6 | 5.8 |
| Example 2 | | | | | | | |
| Comparative | 275.1 | 231.6 | 15.8 | 29 | 20 | 8 | 5.9 |
| Example 3 | | | | | | | |
| Comparative | 256.3 | 206.7 | 19.4 | 25 | 16 | 7.5 | 6 |
| Example 4 | | | | | | | |
| Comparative | 234.6 | 146.2 | 37.7 | 22 | 11 | 6.5 | 7.5 |
| Example 5 | | | | | | | |
| Comparative | 244.7 | 149.6 | 38.9 | 28 | 12 | 7.4 | 6 |
| Example 6 | | | | | | | |
| Comparative | 255 | 155.2 | 39.1 | 27 | 11 | 7 | 6.7 |
| Example 7 | | | | | | | |

As shown in Table 1, it was confirmed that as an indentation hardness (HIT) ratio increased, the average BDV value, minimum BDV value, and MTTF all increased. Particularly, as the indentation hardness (HIT) ratio became greater than 10, both BDV and MTTF increased significantly. Comparing Example 1 and Example 2, as the indentation hardness (HIT) ratio increased by 1.8% from 7.3 to 9.1, the average BDV value, the minimum BDV value, and the MTTF decreased by 4, 3, and 2, respectively. On the other hand, comparing Example 2 and Comparative Example 2, it was confirmed that although the indentation hardness (HIT) ratio increased by 1.1% from 9.1 to 10.2, which decreased by a relatively small amount compared to the above, the BDV average, the BDV minimum, and the MTTF decreased by 8, 10, and 5.5, respectively, so the decreases were relatively large. In conclusion, when the indentation hardness (HIT) ratio is 10% or less, the BDV and MTTF are significantly improved compared to the comparative example.

In addition, through Table 1, it was confirmed that as the indentation hardness (HIT) ratio increases, the decrease in dielectric thickness generally increases.

While this disclosure has been described with practical embodiments, it is understood that the disclosure is not limited to these embodiments. Instead, it covers various modifications and equivalent arrangements within the spirit and scope of the appended claims.

### DESCRIPTION OF SYMBOLS

10: multilayer ceramic capacitor
100: ceramic body
110: dielectric layer
120: first internal electrode
130: second internal electrode
140: first cover layer
150: second cover layer
200: first external electrode
210: first electrode layer
230: first conductive resin layer
250: first plating layer
300: second external electrode
310: second electrode layer
330: second conductive resin layer
350: second plating layer
500: dielectric green sheet

What is claimed is:

1. A multilayer ceramic capacitor comprising
a ceramic body configured to include a dielectric layer therein, and first and second internal electrodes facing each other with the dielectric layer provided therebetween,
wherein the ceramic body satisfies a following conditional equation:
$$0 \leq ( a - b ) / a \leq 0.1 \qquad [ Conditional Equation ]$$
wherein
a: Indentation hardness (HIT) of a lower portion of the ceramic body,
b: Indentation hardness (HIT) of an upper portion of the ceramic body.

2. The multilayer ceramic capacitor of claim 1, wherein
when the ceramic body is divided into two based on a distance from an upper surface to a lower surface, the lower portion of the ceramic body is a portion closest to the lower surface of the ceramic body, and
the upper portion of the ceramic body is a portion closest to the upper surface of the ceramic body.

3. The multilayer ceramic capacitor of claim 1, wherein
when the ceramic body is divided into four based on a distance from an upper surface to a lower surface, the lower portion of the ceramic body is a portion closest to the lower surface of the ceramic body, and
the upper portion of the ceramic body is a portion closest to the upper surface of the ceramic body.

4. The multilayer ceramic capacitor of claim 1, wherein
when the ceramic body is divided into three based on a distance from an upper surface to a lower surface, the lower portion of the ceramic body is a portion closest to the lower surface of the ceramic body, and
the upper portion of the ceramic body is a portion closest to the upper surface of the ceramic body.

5. The multilayer ceramic capacitor of claim 1, wherein
the ceramic body has an upper surface, which is a surface of the upper portion of the ceramic body, and a lower surface, which is a surface of the lower portion of the ceramic body, and
the upper surface is a portion to which a pressure is applied during sintering of the ceramic body.

6. The multilayer ceramic capacitor of claim 1, further comprising:
a first external electrode connected to the first internal electrode; and
a second external electrode connected to the second internal electrode.

7. A multilayer ceramic capacitor comprising:
a ceramic body including a dielectric layer;
first and second internal electrodes facing each other with the dielectric layer provided therebetween;
a first cover layer disposed between an upper surface of the ceramic body and an internal electrode closest thereto; and
a second cover layer disposed between an lower surface of the ceramic body and an internal electrode closest thereto,
and wherein the ceramic body satisfies the following conditional equation:
$$0 \leq ( a - b ) / a \leq 0.1 \qquad [ Conditional Equation ]$$
wherein
a: Indentation hardness (HIT) of a lower portion of the ceramic body, and
b: Indentation hardness (HIT) of an upper portion of the ceramic body.

8. The multilayer ceramic capacitor of claim 7, wherein the first cover layer is formed by stacking at least one dielectric layer on an uppermost internal electrode and a dielectric layer parallel to the uppermost internal electrode.

9. The multilayer ceramic capacitor of claim 7, wherein the second cover layer is formed by stacking at least one dielectric layer under a lowermost internal electrode and a dielectric layer parallel to the lowermost internal electrode.
